(19) United States
(12) Patent Application Publication
(10) Pub. No.: US 2026/0022980 A1
(43) Pub. Date: Jan. 22, 2026

(54) METHOD AND SYSTEM FOR DETERMINING THE TEMPERATURE OF A FLUID FLOWING THROUGH A LINE BODY

(71) Applicant: SIKA DR. SIEBERT & KÜHN GMBH & CO. KG, Kaufungen (DE)

(72) Inventors: René Friedrichs, Göttingen (DE); Stefan Zander, Kassel (DE); Maria Albach, Hessisch Lichtenau (DE); Andreas Brethauer, Alheim (DE)

(73) Assignee: SIKA DR. SIEBERT & KÜHN GMBH & CO. KG, Kaufungen (DE)

(21) Appl. No.: 18/708,306

(22) PCT Filed: Aug. 24, 2022
(86) PCT No.: PCT/EP2022/073544

§ 371 Date: Jul. 14, 2025

(30) Foreign Application Priority Data
Nov. 11, 2021 (DE) 10 2021 129 342.1

(51) Int. Cl. G01K 13/02; G01F 1/58; G01K 7/22

(52) U.S. Cl. CPC G01K 13/026; G01F 1/58; G01K 7/22

(57) ABSTRACT

A method for determining the temperature of a fluid flowing through a line body includes: generating a thermal model of the line body, the model being suitable for calculating the time curve of the surface temperature of a measurement section of the exterior of the line body from a known time curve of the fluid temperature; and continuously repeating the following steps: calculating the surface temperature of the measurement section of the line body exterior using the thermal model on the basis of an estimated value of the fluid temperature; measuring the surface temperature of the measurement section of the line body exterior; correcting the estimated value of the fluid temperature such that the measured surface temperature has the highest degree of probability on the basis of the corrected estimated value of the fluid temperature in the thermal model; and outputting the corrected estimated value of the fluid temperature.

### CROSS-REFERENCE TO RELATED APPLICATIONS

This application is the U.S. National Stage of PCT/EP2022/073544 filed on Aug. 24, 2022, which claims priority to German Patent Application 102021129342.1 filed on Nov. 11, 2021, the entire content of both are incorporated herein by reference in their entirety.

### FIELD OF THE INVENTION

The invention relates to a method of determining the temperature of a fluid flowing through a line body and to a system for carrying out the method in accordance with the invention.

### BACKGROUND OF THE INVENTION

Determining the temperature of a flowing fluid within a line body, for example a pipe, is a frequent problem in the area of a large number of industrial processes. It may be advantageous or necessary here to carry out a non-invasive, indirect temperature measurement, i.e. in particular to dispense with the use of temperature sensors projecting into the fluid.

DE 10 2017 116 533 A1 and DE 100 29 186 A1, for example, disclose contact temperature sensors that are provided for arrangement at the outer side of the pipe that is flowed through and that measure the temperature of the outer pipe side as a measure for the temperature of the fluid. Such an arrangement at the outer side advantageously makes a replacement of the temperature sensor possible without interrupting the process. In addition, such a non-invasive temperature measurement is also hygienically advantageous since no disruptive body projects into the flowing fluid at which deposits can form and that represents an obstacle during the inner wall pipe cleaning (pigging). Seal points at the pipe are additionally avoided, which is above all advantageous in high pressure processes and high temperature processes. Furthermore no unwanted turbulence or pressure losses can be generated in the flowing fluid by the non-invasive temperature measurement. The large inaccuracy of the temperature measurement at the outer pipe side is in contrast also disadvantageous with respect to the true temperature of the fluid in the pipe interior. The temperature of the pipe is determined at best by means of the contact temperature sensors, which only represents a rough approximation for the temperature of the fluid, in particular with dynamic temperature progressions. The deviation is the larger here; the thicker the pipe wall, the smaller the thermal conductivity of the pipe, and the smaller the Reynold [symbol] s number of the fluid.

DE 10 2017 116 505 A1 furthermore discloses a sensor for the determination of the temperature of a medium comprising a first temperature sensor having a first thermal response behavior and a second temperature sensor having a second thermal response behavior that differs from the first thermal response behavior, with there being a defined thermal resistance between the two temperature sensors and the difference signal of the temperature sensors serving as a basis for the calculation of the medium temperature. The necessity of using at least two temperature sensors and the insufficient adaptability of the measurement design to conditions specifically prevailing at the measurement site is disadvantageous here.

### SUMMARY OF THE INVENTION

It is therefore the object of the present invention to provide an alternative method and an associated system for determining the temperature of a fluid flowing through a line body that is based on a simple non-invasive measurement and is in particular suitable for determining dynamic temperature progressions.

This object is achieved starting from a method and a system as disclosed herein. Advantageous further developments of the invention are also disclosed.

The invention includes the technical teaching that the method of determining the temperature of a fluid flowing through a line body comprises at least the following steps:
preparing a thermal model of the line body, with the thermal model being suitable to calculate the time progression of the surface temperature of a measurement section of the outer side of the line body from a known time progression of the fluid temperature; and
continuously repeating the following steps:
   i. calculating the surface temperature of the measurement section of the outer side of the line body by means of the thermal model based on an estimated value of the fluid temperature;
   ii. measuring the surface temperature of the measurement section of the outer side of the line body;
   iii. correcting the estimated value of the fluid temperature such that the measured surface temperature based on the corrected estimated value of the fluid temperature in the thermal model is the most likely; and
   iv. outputting the corrected estimated value of the fluid temperature.

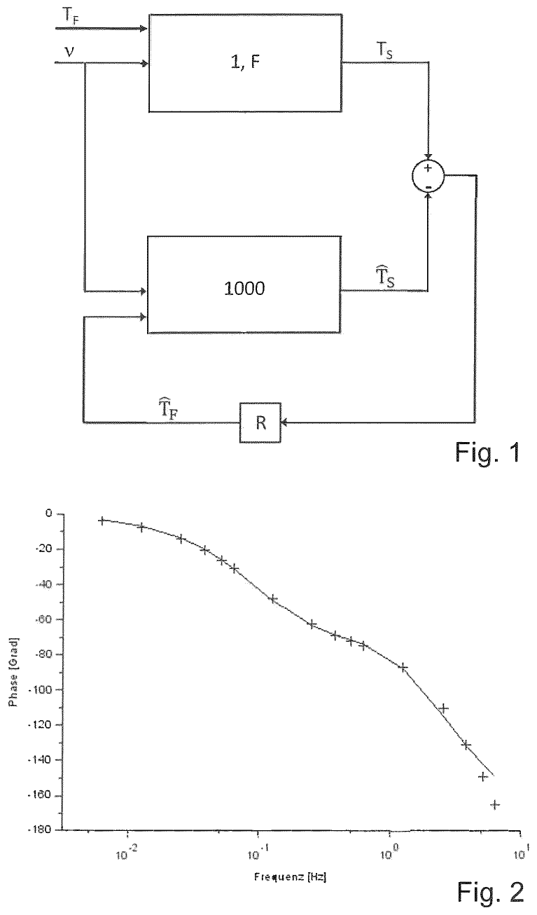

The key idea of the invention comprises comparing the temperature progression measured at the outer side of the line body with corresponding estimated values that result from the calculation by means of the thermal model, with it being assumed on a convergence of the estimated temperature progression to the measured temperature progression that the progression of the fluid temperature underlying the calculation also converges to the progression of the true fluid temperature. The method in accordance with the invention is similar to a feedback loop, as shown in FIG. 1. The physical system of the line body 1 and the fluid F flowing through is modeled by the thermal model 1000. The time progression of the fluid temperature T_{F} has to be determined, with the time progression of the surface temperature Ts being detected on the outer side of the line body 1 by a technical measurement. A calculation value of the surface temperature \hat{T}ₛ is calculated by means of the thermal model 1000 based on the known volume flow v of the fluid F and on an expediently selected starting value of the estimated fluid temperature \hat{T}_{F}. A comparison of the measured surface temperature Tₛ with the estimated surface temperature \hat{T}ₛ is subsequently carried out in every time step and a feedback loop is run through by the regulator R that forms a corrected value of the estimated fluid temperature \hat{T}_{F} based on the comparison and hands it over to the thermal model 1000. A fast convergence of the estimated values \hat{T}_{F} to the true values T_{F} can be achieved, for example, by means of a regulator R in the form of a Kalman filter, as will be explained in detail in the following. The corrected values of the estimated fluid temperature \hat{T}_{F} are then output as a measure for the true fluid temperature T_{F} to be determined. In accordance with the invention, in particular a mean fluid temperature is determined, i.e. temperature gradients possibly present in the flow cross-section are averaged.

In an advantageous embodiment of the method in accordance with the invention, numerical solutions of the heat equation are determined by means of the finite element method when preparing the thermal model, with a convective heat transfer and/or heat radiation being taken into account for the fixing of boundary conditions of the heat equation at the inner side and at the outer side of the line body. The heat equation is:

$$ρ c \frac{\partial T}{\partial t} - λ {∇}^{2} T - f = 0 ,$$

with the temperature T, the density p, the specific heat capacity c, the thermal conductivity λ, and the thermal source density ƒ. Boundary conditions from convection and/or radiation are defined in the integration of the heat equation for the thermal transport between the fluid and the line body at its inner side and between the environment and the line body at its outer side. The following approach is made for the heat flow density with respect to the convection:

$$\dot{q} = αΔ T ,$$

with the heat transfer coefficient ⋅ that in particular depends on the flow relationships of the fluid within the boundary layer toward the inner side of the line body. The Nusselt number preferably forms the starting point for the quantification of the heat transfer coefficient:

$$Nu = \frac{α L}{{λ}_{F}} ,$$

with the thermal conductivity of the fluid λ_{F} and a characteristic length L that is to be selected respectively expediently in dependence on the specific flow situation and the geometry of the line body. In particular on the presence of forced convection, the Nusselt number can expediently be given as a function of the associated Reynold [symbol] s number and Prandtl number or, in the case of free convection, by means of the Grasshof number and Prandtl number. Empirically determined expressions of the Nusselt number are in particular known from the technical literature for a large number of line body geometries.

The line body can be described in simplified form, for example, as a gray radiator to take account of heat transport by irradiation and absorption at its surfaces.

If a device having a temperature sensor in thermal contact with the outer side of the line body is used for the measurement of the surface temperature of the measurement section of the outer side of the line boy, the thermal model of the line body is preferably expanded to include this device. A measurement current through the temperature sensor could, for example, generate an ohmic power loss and the corresponding thermal source density would be considered in the solution of the heat equation.

The thermal model is in particular prepared for a further value range of volume flows of the fluid flowing through. Against the background of the preceding representation, it is furthermore obvious to the skilled person that, in accordance with the invention, any desired fluids (liquids, gases) and any desired line bodies of the most varied geometries and materials or material combinations can be observed in the preparation of the thermal model.

Alternatively or in addition to the preparation of the thermal model by means of numerical solutions of the heat equation, the time progression of the fluid temperature and the time progression of the surface temperature of the measurement section of the outer side of the line body can be simultaneously measured for the preparation of the thermal model. In this respect, such a time progression of the fluid temperature is preferably predefined that is expediently adapted to the specifically present application case with respect to the temperature range covered and the time temperature gradients. Different fluid volume flows or time progressions of the volume flow can furthermore be specified.

In an advantageous embodiment of the method in accordance with the invention, the thermal model is formulated as a dynamic transfer system in a state space representation, with the continuous calculation of the surface temperature being carried out by means of the state space representation of the thermal model. A mathematical model of a procedure is called a dynamic transfer system here that converts or transmits an input signal as an output signal, with the time progression of the fluid temperature being considered an input signal and the corresponding progression of the surface temperature of the measurement sections of the outer side of the line body being considered an output signal in the present case. The state space representation of the transfer system is particularly suitable for the system analysis in the temporal range and is particularly efficient in a technical regulation treatment. In the state space representation, all the relationships of the input, output, and state variables are shown in the form of matrices and vectors.

The following steps are, for example, carried out for the formulation of the thermal model in the state space representation:
calculating the frequency response of the thermal model for different frequencies of harmonic variations of the fluid temperature at different volume flows of the fluid;
carrying out a curve fitting to model the frequency response by means of a transfer function;
determining an associated linear differential equation by means of inverse Laplace transformation of the transfer function; and
obtaining the state space representation by converting the differential equation into a system of coupled first order differential equations.

In particular sinusoidal temperature progressions are input into the thermal model as an input signal for the calculation of the frequency response and the stationary output signal corresponds to the calculated progression of the surface temperature on the outer side of the line body. The frequency of the input signal is harmonically varied here, for example in the range from 10⁻³ Hz to 10 Hz. The frequency response is furthermore calculated for a plurality of different fluid volume flows. FIG. 2 shows by way of example the phase response of a calculated frequency response (cross symbols) together with an associated modeling and as the result of a curve fitting by means of a transfer function (solid line). To be able to quickly carry out the calculation steps carried out continuously in the method in accordance with the invention by means of the thermal model, the transfer function used for the modeling preferably only has three to five poles and/or zeroes. The transfer function shown in the example of FIG. 2 has four corresponding time constants θ, τ₁, τ₂ and τ₃, and reads:

$$G ( i ω ) = \frac{k ( 1 + θ i ω )}{( 1 + {τ}_{1} i ω ) ( 1 + {τ}_{2} i ω ) ( 1 + {τ}_{3} i ω )} .$$

The following differential equation results from this by means of an inverse Laplace transformation:

$${q}^{...} ( t ) + {a}_{1} \ddot{q} ( t ) + {a}_{2} \dot{q} ( t ) + {a}_{3} q ( t ) = {b}_{0} \dot{u} ( t ) + {b}_{1} u ( t ) ,$$

where u(t)=T_{F}(t) (fluid temperature), q(t)=T_{S}(t) (surface temperature) and

$${a}_{1} = \frac{{τ}_{1} {τ}_{2} + {τ}_{1} {τ}_{3} + {τ}_{2} {τ}_{3}}{{τ}_{1} {τ}_{2} {τ}_{3}}$$

$${a}_{2} = \frac{{τ}_{1} + {τ}_{2} + {τ}_{3}}{{τ}_{1} {τ}_{2} {τ}_{3}} ,$$

$${a}_{3} = \frac{1}{{τ}_{1} {τ}_{2} {τ}_{3}} ,$$

$${b}_{0} = \frac{k θ}{{τ}_{1} {τ}_{2} {τ}_{3}} ,$$

$${b}_{1} = \frac{k}{{τ}_{1} {τ}_{2} {τ}_{3}} .$$

By means of the substitutions:

$${x}_{1} = q ,$$

$${x}_{2} = \dot{q} ,$$

$${x}_{3} = \ddot{q} - {b}_{0} u ,$$

$${\dot{x}}_{1} = {x}_{2} = \dot{q} ,$$

$${\dot{x}}_{2} = \ddot{q} = {x}_{3} + {b}_{0} u ,$$

$${\dot{x}}_{3} = {q}^{...} - {b}_{0} \dot{u} = - {a}_{3} q - {a}_{2} \dot{q} - {a}_{1} \ddot{q} + {b}_{1} u = - {a}_{3} {x}_{1} - {a}_{2} {x}_{2} - {a}_{1} {x}_{3} + ( {b}_{1} - {a}_{1} {b}_{0} ) u$$

the above differential equation is converted into a system of coupled first order differential equations and the state space representation of the thermal model for the present examples thus reads:

$${x}^{\dot{⇀}} ( t ) = ( \begin{matrix}0 & 1 & 0 \\ 0 & 0 & 1 \\ - {a}_{1} & - {a}_{2} & - {a}_{3}\end{matrix} ) \vec{x} ( t ) + ( \begin{matrix}0 \\ {b}_{0} \\ {b}_{1} - {a}_{1} {b}_{0}\end{matrix} ) u ( t ) = M \vec{x} ( t ) + Gu ( t ) .$$

In this respect, the elements of the matrices M and G are determined by means of numerical or analytical integration or differential equations and are stored such that the elements can be provided in the carrying out of the method in accordance with the invention, i.e. in the calculation of the progression of the surface temperature by means of the thermal model based on the estimated progression of the fluid temperature, for example on a microcontroller or on another compact electronic data processing unit and thus make a very fast calculation possible. The matrix elements are in particular determined and stored for a plurality of different fluid volume flows v, i.e. M(v) and G(v).

For a time discrete modeling of the temperature dynamics for the points in time tₙ₊₁=tₙ+Δt with a suitable time increment Δt, the state space representation of the thermal model is formulated by means of the linear differential equations

$${\vec{x}}_{n + 1} = M {\vec{x}}_{n} + {Gu}_{n}$$

for the states [symbol] ₙ= [symbol] (tₙ), uₙ=(tₙ).

A Kalman filter is preferably used to correct the estimated value of the fluid temperature. The Kalman filter is a mathematical process for the iterative estimate of parameters for describing system states based on defective observations and serves to estimate system parameters that cannot be measured directly, whereas the errors of the measurement are optimally reduced (see, for example, L. F. Mouzinho, J. V. FonsecaNeto, B. A. Luciano und R. C. S. Freire, [symbol] Indirect Measurement of the temperature via Kalman filter [symbol] , XVIII IMEKO World Congress, Metrology for a Sustainable Development, 17th-22nd Sep. 2006, Rio de Janeiro, Brazil). With dynamic parameters, a mathematical model, the thermal model of the line body here, can be added to the filter as a secondary condition to take account of dynamic relationships between the system parameters. The Kalman filter is used within the framework of the method in accordance with the invention to estimate the fluid temperature not directly measurable as best as possible from the defective measurement of the surface temperature of the outer side of the line body, i.e. to correct the estimated progression of the fluid temperature such that the measured progression of the surface temperature based on the corrected progression of the fluid temperature is the most likely in the thermal model.

The unknown fluid temperature T_{F}(tₙ) is first observed as a component yₘ(tₙ) of an expanded state vector

$$\vec{y} = ( \begin{matrix}{y}_{1} ( {t}_{n} ) \\ {y}_{2} ( {t}_{n} ) \\ … \\ {y}_{m} ( {t}_{n} )\end{matrix} ) = ( \begin{matrix}{T}_{S} ( {t}_{n} ) \\ {\dot{T}}_{S} ( {t}_{n} ) \\ … \\ {T}_{F} ( {t}_{n} )\end{matrix} )$$

with an associated covariance matrix of the errors of [symbol] (tₙ)

$$P ( {t}_{n} ) = ( \begin{matrix}{p}_{1 , 1} ( {t}_{n} ) & … & … & {p}_{1 , m} ( {t}_{n} ) \\ … & … & … & … \\ … & … & … & … \\ {p}_{m , 1} ( {t}_{n} ) & … & … & {p}_{m , m} ( {t}_{n} )\end{matrix} ) .$$

The volume flow dependent transfer matrix for the predictive step of the Kalman filter that propagate the state [symbol] (tₙ) into the state [symbol] (tₙ₊₁) accordingly reads

$$A ( v ) = ( \begin{matrix}M ( v ) & G ( v ) \\ 0 …0 & 1\end{matrix} ) .$$

Since the dynamics of the estimated surface temperature is completely deterministic in the thermal model, but the dynamics of the real fluid temperature is not deterministic, only the last element q_{m,m} of the matrix of the process noise of the Kalman filter

$$Q = ( \begin{matrix}0 & … & … & 0 \\ … & … & … & … \\ … & … & 0 & 0 \\ 0 & … & 0 & {q}_{m , m}\end{matrix} )$$

has a value different from 0. The amount of this strictly positive value q_{m,m} corresponds to the variance of the process noise of the fluid temperature T_{F}(tₙ).

It must be taken into account when using the Kalman filter that the measured values z(tₙ) resulting on the measurement of the surface temperature have interference from noise with the variation R. With an exclusive measurement of the surface temperature, the observation matrix reads

$$H = ( \begin{matrix}1 & 0 & … & 0\end{matrix} ) ,$$

so that

$$z ( {t}_{n} ) = H \vec{y} ( {t}_{n} ) + R .$$

The process in the estimate of the fluid temperature yₘ(tₙ)=T_{F}(tₙ) by means of the Kalman filter at the points in time tₙ preferably comprises the following steps:
n=0 and initialization of the state vector [symbol] (t₀) and of the associated covariance matrix P(t₀) preferably by means of the measured value z(t₀) for the surface temperature T_{S}(t₀) determined at the point in time t₀ and, for example, with the value of the variance R of the measurement noise and the value of the process noise q_{m,m}:

$$\vec{y} ( {t}_{0} ) = ( \begin{matrix}z ( {t}_{0} ) \\ 0 \\ 0 \\ z ( {t}_{0} )\end{matrix} ) and P ( {t}_{0} ) = ( \begin{matrix}R & 0 & … & 0 \\ 0 & {q}_{m , m} & 0 & … \\ … & 0 & {q}_{m , m} & 0 \\ 0 & … & 0 & {q}_{m , m}\end{matrix} ) .$$

1. Specifying the fluid volume flow v (for example from a measurement) at the point in time tₙ₊₁ and determining the associated transfer matrix A(v). The elements of the transfer matrix A(v) are preferably determined in advance for relevant volume flows and are stored in a memory.
2. Predicting the new state [symbol] (tₙ₊₁) and the new covariance matrix P⁻(tₙ₊₁) in accordance with the calculation rule of the Kalman filter:

$${\vec{y}}^{-} ( {t}_{n + 1} ) = A \vec{y} ( {t}_{n} )$$

$$and$$

$${P}^{-} ( {t}_{n + 1} ) = AP ( {t}_{n} ) {A}^{T} + Q .$$

3. Determining the measured value z(tₙ₊₁) for the surface temperature T_{S}(tₙ₊₁) at the point in time tₙ₊₁.
4. Correcting the predicted new state and the new covariance matrix by means of the Kalman gain matrix

$$K ( {t}_{n + 1} ) = {P}^{-} ( {t}_{n + 1} ) {{H}^{T} [ {HP}^{-} ( {t}_{n + 1} ) {H}^{T} + R ]}^{- 1}$$

in accordance with the rules

$$\vec{y} ( {t}_{n + 1} ) = {\vec{y}}^{-} ( {t}_{n + 1} ) + K ( {t}_{n + 1} ) [ z ( {t}_{n + 1} ) - H {\vec{y}}^{-} ( {t}_{n + 1} ) ]$$

$$and$$

$$P ( {t}_{n + 1} ) = [ I - K ( {t}_{n + 1} ) H ] {P}^{-} ( {t}_{n + 1} ) .$$

5. Outputting the component yₘ(tₙ₊₁) of the state vector as the current fluid temperature T_{F}(tₙ₊₁).
6. n=n+1 and return to step 1.

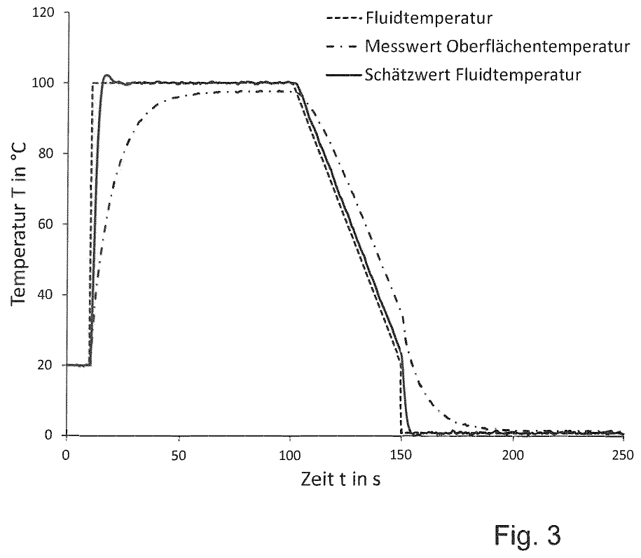

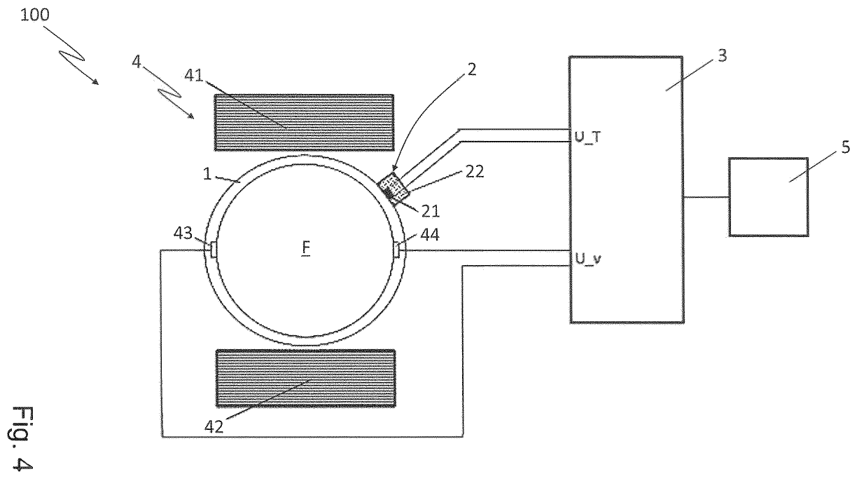

The use of the Kalman filter in particular results in the corrected predicted state containing an estimated value of the fluid temperature based on which the measured surface temperature in the thermal model is the most likely. FIG. 3 demonstrates the performance of the method in accordance with the invention using the Kalman filter. By way of example, a temperature progression of a fluid flowing through a cylindrical pipe as the line body is shown therein in a synopsis with the associated progressions of the measured values of the surface temperature at the outer side of the pipe that are used in the prior art as a measure for the fluid temperature and of the estimated values of the fluid temperature determined by means of the method in accordance with the invention.

Parameters that vary in the operation of a system monitored by means of the method in accordance with the invention such as the fluid volume flow can be measured and taken into account by separate sensors. For example, an adaptation of the probability distribution of the temporal variation of the fluid temperature to changed operating conditions can be carried out. A change of the fluid temperature in particular also occurs with a high probability on changes of the fluid volume flow. This can be taken into account in that the assumed variance of the probability distribution for changes of the fluid temperature is increased on changes of the fluid volume flow.

The continuous measurement of the surface temperature of the measurement section of the outer side of the line body is preferably carried out at a sample rate of at least 2 Hz. It has been shown that a frequent measured value detection or a high sample rate and low noise of the measured value detection is of advantage for a high performance of the method in accordance with the invention, i.e. a short response time and low noise of the fluid temperatures determined by the method. The surface temperature is therefore preferably measured at a sample rate of at least 2 Hz (Δt≤0.5 s) that is otherwise unusually high for temperature measurements. The noise of the surface temperature measurement should also preferably be smaller than 0.1 Kelvin (standard deviation of the measurement noise) or smaller than 0.01 K² (variance R of the measurement noise).

In an advantageous embodiment, the volume flow of the fluid through the line body is determined by means of continuous measurements, with the measured progression of the volume flow, as above, being taken into account in the calculation of the progression of the surface temperature.

The invention furthermore relates to a system for determining the temperature of a fluid flowing through a line body, wherein the system is configured to carry out the method in accordance with an above embodiment and at least comprises:
a device for measuring the surface temperature of a measurement section of the outer side of the line body; and
a processing unit with a display device for continuously determining and outputting the estimated value of the fluid temperature by means of the corresponding steps of the method in accordance with the invention.

The thermal model is in particular stored in a memory of the processing unit.

The device for measuring the surface temperature preferably has a temperature sensor, in particular a thermal element or a platinum measurement resistor, with the temperature sensor being in thermal contact with the measurement section of the outer side of the line body and being thermally insulated from the environment of the line body by means of an insulation material. In principle, however, other methods of the temperature measurement can also be used within the framework of the method in accordance with the invention, based on pyrometry, for example.

In an advantageous embodiment, the system has a device for measuring the volume flow of the fluid through the line body, wherein the device for measuring the volume flow can in particular be designed as a magnetic flow meter.

### PREFERRED EMBODIMENT OF THE INVENTION

Further measures improving the invention will be shown in more detail below together with the description of a preferred embodiment of the invention with reference to FIG. 4.

FIG. 4 shows a schematic cross-sectional view of a system 100 in accordance with the invention for determining the temperature of the fluid F flowing through the line body 1 by means of carrying out the method in accordance with the invention. The line body 1 is formed as a cylindrical pipe.

The system 100 comprises the device 2 for measuring the surface temperature of a measurement section of the outer side of the line body 1, with the device 2 having the temperature sensor 21 in thermal contact with the outer side of the line body 1 and being thermally insulated from the environment of the line body 1 by means of an insulating material 22. The contact surface between the temperature sensor 21 and the line body 1 defines the measurement section of the outer side. The insulation material 22 is formed, for example, from a plastic having small thermal conductivity. The device 2 is surrounded by a mechanically stable housing and is pressed by a clip (not shown), for example, to the line body 1.

The system furthermore comprises the processing unit 3 having the display device 5, with the processing unit 3 being configured for
calculating the surface temperature of the measurement section of the outer side of the line body 1 by means of the thermal 1000 model based on an estimated value of the fluid temperature;
correcting the estimated value of the fluid temperature such that the measured surface temperature based on the corrected estimated value of the fluid temperature in the thermal model is the most likely; and
outputting the corrected estimated value of the fluid temperature on the display device 5.

In the present case, the processing unit 5 is furthermore configured to receive and evaluate sensor signals of the temperature sensor 21 and of the measurement electrodes 43, 44.

In an advantageous embodiment, the system has a device 4 for measuring the volume flow of the fluid F through the line body, wherein the device 4 is designed as a magnetic flow meter. A magnetic field penetrating the line body 1 can be generated by means of the field coils 41, 42 and the measurement electrodes 43, 44 arranged transversely to the magnetic field serve the detection of a measurement voltage inductively generated in the fluid.

The combination of two non-invasive measurement methods for the simultaneous determination of the fluid temperature and the fluid volume flow represents a particular advantage of the system 100 in accordance with the invention and enables a precise and permanent process monitoring without any disruptive interventions in the fluid flow in the interior of the line body 1.

The invention is not restricted in its design to the preferred embodiment specified above. A number of variants is rather conceivable that also makes use of the solution shown with generally differently designed embodiments. All the features and/or advantages, including any construction details, spatial arrangements, or method steps, originating from the claims, the description or the drawings can be essential to the invention both per se and in the most varied combinations.

### REFERENCE NUMERAL LIST

100 system
1 line body
2 device for temperature measurement
21 temperature sensor
22 insulation material
3 processing unit
4 device for volume flow measurement
41, 42 field coil
43, 44 measurement electrode
5 display device
1000 thermal model
F fluid
R regulator
T_{F} fluid temperature
\hat{T}_{F} estimated value of the fluid temperature
Tₛ measured value of the surface temperature
\hat{T}ₛ calculation value of the surface temperature

1. A method of determining the temperature of a fluid flowing through a line body at least comprising the following steps:
preparing a thermal model of the line body, with the thermal model being suitable to calculate a time progression of a surface temperature of a measurement section of an outer side of the line body from a known time progression of the fluid temperature; and
continuously repeating the following steps:
i. calculating the surface temperature of the measurement section of the outer side of the line body by means of the thermal model based on an estimated value of the fluid temperature;
ii. measuring the surface temperature of the measurement section of the outer side of the line body;
iii. correcting the estimated value of the fluid temperature such that the measured surface temperature based on the corrected estimated value of the fluid temperature in the thermal model is the most likely; and
iv. outputting the corrected estimated value of the fluid temperature.

2. A method in accordance with claim 1, wherein
numerical solutions of the heat equation are determined by means of the finite element method to prepare the thermal model, with a convective heat transfer and/or heat radiation being taken into account for the fixing of boundary conditions of the heat equation at the inner side and at the outer side of the line body.

3. A method in accordance with claim 1, wherein
the time progression of the fluid temperature and the time progression of the surface temperature of the measurement section of the outer side of the line body are simultaneously measured to prepare the thermal model.

4. A method in accordance with claim 1, wherein
the thermal model is formulated as a dynamic transfer system in a state space representation, with the continuous calculation of the surface temperature being carried out by means of the state space representation of the thermal model.

5. A method in accordance with claim 4, wherein
the following steps are carried out for a formulation of the thermal model in a state space representation:
calculating a frequency response of the thermal model for different frequencies of harmonic variations of the fluid temperature at different volume flows of the fluid;
carrying out a curve fitting to model the frequency response by means of a transfer function;
determining an associated linear differential equation by means of inverse Laplace transformation of the transfer function; and
obtaining the state space representation by converting the differential equation into a system of coupled first order differential equations.

6. A method in accordance with claim 5, wherein
the transfer function has three to five poles and/or zeroes.

7. A method in accordance with claim 1, wherein
a Kalman filter is used to correct the estimated value of the fluid temperature.

8. A method in accordance with claim 1, wherein
the continuous measurement of the surface temperature of the measurement section of the outer side of the line body is carried out by means of a device having a temperature sensor in thermal contact with the measurement section, with the device being taken into account in the preparation of the thermal model of the line body.

9. A method in accordance with claim 1, wherein
the continuous measurement of the surface temperature of the measurement section of the outer side of the line body is carried out at a sample rate of at least 2 Hz.

10. A method in accordance with claim 1, wherein
the volume flow of the fluid through the line body is determined by means of continuous measurements, with a measured progression of the volume flow being taken into account in the calculation of the progression of the surface temperature.

11. A system for determining a temperature of a fluid flowing through a line body, wherein the system is configured to carry out a method in accordance with claim 1 and at least comprises:
a device for measuring a surface temperature of a measurement section of the outer side of the line body; and
a processing unit having a display device for
i. calculating the surface temperature of the measurement section of the outer side of the line body by means of a thermal model based on an estimated value of the fluid temperature;
ii. correcting the estimated value of the fluid temperature such that the measured surface temperature based on the corrected estimated value of the fluid temperature in the thermal model is the most likely; and
iii. outputting the corrected estimated value of the fluid temperature on the display device.

12. A system in accordance with claim 11, wherein
the device for measuring the surface temperature has a temperature sensor, in particular a thermal element or a platinum measurement resistor, with the temperature sensor being in thermal contact with the measurement section of the outer side of the line body and being thermally insulated from the environment of the line body by means of an insulation material.

13. A system in accordance with claim 11, wherein
the system has a device for measuring a volume flow of the fluid through the line body.

14. A system in accordance with claim 13, wherein
the device for measuring the volume flow of the fluid is configured as a magnetic flow meter.
